(19) United States
(12) Patent Application Publication
(10) Pub. No.: US 2007/0268873 A1
(43) Pub. Date: Nov. 22, 2007

(54) Wireless Communication Session Handover Method and Apparatus for use with Different Wireless Access Technologies

(75) Inventors: Michael Borella, Naperville, IL (US); Chandra Warrier, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTSTARCOM, INC., Alameda, CA (US)

(21) Appl. No.: 11/383,977

(22) Filed: May 18, 2006

(51) Int. Cl. H04Q 7/24

(52) U.S. Cl. 370/338; 370/401

(57) ABSTRACT

A first and a second, different wireless access technology are supported (101 and 102) via an access gateway (200). The first wireless access technology, for example, can serve to facilitate provision of a wireless communication session with a given mobile station (104). Using (105) a received first identifier that correlates the mobile station to the first wireless access technology and a received second identifier that correlates the mobile station to the second wireless access technology, this access gateway can then, when appropriate, effect (106) a handover of that wireless communication session for that mobile station from the first wireless access technology to the second wireless access technology.

### TECHNICAL FIELD

This invention relates generally to wireless communications and more particularly to a handover of a present wireless communication session.

### BACKGROUND

Wireless communications are well known in the art with many different wireless access technologies serving in different networks to facilitate such communications. CDMA2000, for example, comprises an example of a successfully deployed wireless access technology that, in a typical application setting, offers wide area coverage for both voice and data communications. Many of these wireless access technologies are configured and arranged to accommodate the real-time movement of supported mobile stations. In particular, as a mobile station moves from one coverage area (such as a so-called cell) to another, many such wireless access technologies will effect a handover of a presently-conducted wireless communication session for that mobile station from a point of attachment that serves the first coverage area to a point of attachment that serves the second coverage area.

Interest grows with respect to deploying mobile stations that are agile with respect to the wireless access technologies that may be used by such mobile stations. For example, interest exists regarding the design and manufacture of a mobile station that is capable of compatibly using a first wireless access technology such as CDMA2000 as well as a second wireless access technology such as WiMAX (the latter corresponding to the I.E.E.E. 802.16(e) family of limited-range wireless communications).

Such convergence, however, presents new challenges. As one significant example in this regard, though a given wireless access technology may be configured to facilitate a handover of an ongoing wireless communication within the confines of that wireless access technology, there may be times when a handover of an ongoing wireless communication from a first wireless access technology to a second, different wireless access technology may be desired, useful, and/or critical with respect to properly supporting that wireless communication. Present solutions and wireless system management paradigms are at least inefficient and, in many cases, wholly inadequate to meet such a need.

### BRIEF DESCRIPTION OF THE DRAWINGS

The above needs are at least partially met through provision of the wireless communication session handover method and apparatus for use with different wireless access technologies described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a block diagram as configured in accordance with various embodiments of the invention; and

FIG. 5 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a first and a second, different wireless access technology are supported via an access gateway. The first wireless access technology, for example, can serve to facilitate provision of a wireless communication session with a given mobile station. Using a received first identifier that correlates the mobile station to the first wireless access technology and a received second identifier that correlates the mobile station to the second wireless access technology, this access gateway can then, when appropriate, effect a handover of that wireless communication session for that mobile station from the first wireless access technology to the second wireless access technology.

These first and second identifiers can be initially sourced, using one approach, by the mobile station itself. For example, if desired, both identifiers can be provided in a shared message. The identifiers themselves can vary with the needs and/or opportunities presented by a given application setting.

By one approach, the aforementioned handover can comprise establishing a connection with the mobile station using the second wireless access technology without anticipation of the handover. The handover can then be later effected as noted. By another approach, the aforementioned handover can comprise establishing this connection while in fact anticipating the imminent handover. The handover can then again be effected as noted.

Those skilled in the art will understand and appreciate the ease by which these teachings may be deployed and employed to facilitate inter-network handovers of ongoing wireless communications. For example, the mobile station may act in accordance with these teachings without requiring the use of any additional identifiers beyond those with which the mobile station is already provisioned. These teachings provide a relatively simple and highly scalable and leverageable mechanism to effect handovers as between any of a wide variety of differing wireless access technologies including, but certainly not limited to, CDMA2000-compatible wireless access technology, 802.16(e)-compatible wireless access technology, and so forth.

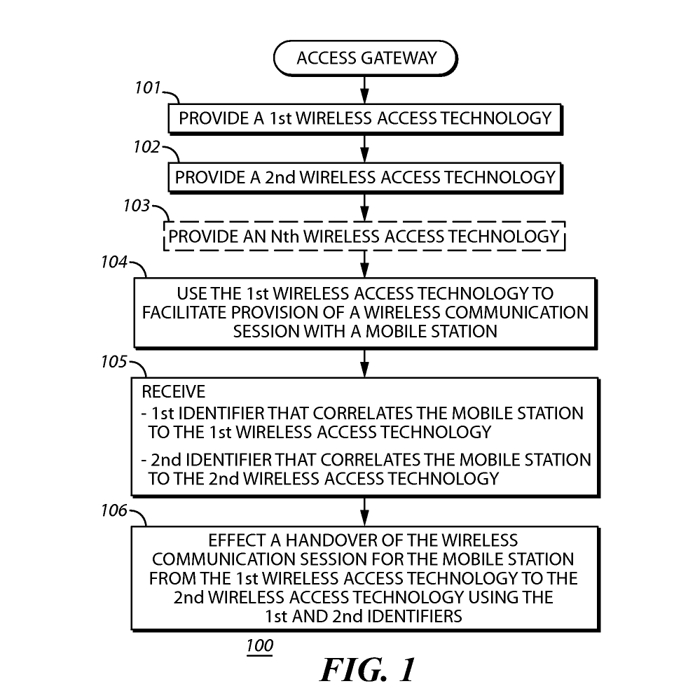

These and other benefits may become clearer upon making a thorough review and study of the following detailed description. Referring now to the drawings, and in particular to FIG. 1, an access gateway can support provision 101 of a first wireless access technology as well as provision 102 of a second wireless access technology. (If desired, any number of additional wireless access technologies can be similarly provided 103; for the sake of clarity and simplicity, however, the illustrative examples presented here will presume the provision of only a first and a second wireless access technology.)

As used herein, the expression wireless access technology will be understood to refer to the technology that comprises a wireless point of attachment for at least one given mobile station. This will typically encompass, but is not necessarily limited to, characterizing requirements regarding modulation, signaling protocols, bearer channels, and the like. In a typical embodiment the first and second wireless access technologies will be different from one another; that is, their requirements for compatible usage will be different from one another in some significant way. For the purposes of presenting a non-exhaustive illustration and not by way of limitation, the first wireless access technology could comprise a CDMA2000-compatible wireless access technology and the second wireless access technology could comprise an 802.16(e)-compatible wireless access technology.

This process 100 then provides for using one of these wireless access technologies to facilitate provision of a wireless communication session with a given mobile station. For purposes of this example and not by way of limitation, this can comprise using 104 the first wireless access technology to facilitate provision of a wireless communication session with a given mobile station. This wireless communication session can comprise, for example, a voice communication, a data communication (including, for example, a file transfer, a streaming transfer, or such other data transfer as may be of interest), or the like. The specifics of this step will of course vary with the wireless access technology itself. As these teachings are not overly sensitive to the selection of any particular wireless access technology in this regard, for the sake of brevity and clarity additional elaboration with respect to this step will not be presented here.

This process 100 also provides for the access gateway receiving 105 both a first identifier that correlates the mobile station to the first wireless access technology and a second identifier that correlates the mobile station to the second wireless access technology. By one approach the first and second identifier may be identical to one another but will likely be different from one another in a typical deployment setting. Various known identifiers may serve in this regard. An illustrative but non-exhaustive listing would likely include international mobile subscriber identities (IMSI), electronic serial numbers (ESN), mobile equipment identifiers (MEID), network access identifiers (NAI), and media access control (MAC) addresses, to note but a few (and all of which are known and well understood in the art).

In a typical (though not necessarily required) application setting these first and second identifiers will be initially sourced by the corresponding mobile station. The access gateway can receive such information, for example, via a base station as comprises a point of attachment for the mobile station. By one approach these identifiers can be provided via separate messaging transactions. In many application settings, however, it may be useful and beneficial to provide the first and second identifiers in a shared message. For example, when using the first wireless access technology as a means of attachment, the mobile station can present the first identifier (which correlates to the first wireless access technology) in one part of a first wireless access technology message while presenting the second identifier in another part of that first wireless access technology message.

By one approach, the second identifier could be nested within a specific message field that is reserved for such information and/or that is allocated for use in presenting any of a variety of data types. When the field is not reserved solely for presentation of such an identifier, it may also be useful to include a secondary indicator that serves to identify the second identifier as being, in fact, a second identifier.

The access gateway can then use these identifiers to recognize and identify that a given mobile station is able to communicate using these two different access technologies. This knowledge, in turn, can serve to facilitate effecting 106 a handover (when appropriate and/or necessary) of the aforementioned wireless communication session for the wireless mobile station from the first wireless access technology to the second wireless access technology. By one approach, this can comprise establishing a connection with the mobile station using the second wireless access technology without anticipating such a handover and then later effecting the handover using that connection. Such an approach will serve, for example, when the mobile station initiates attachment to a given network using the second wireless access technology and when the access gateway facilitates that initial attachment without concern for whether the mobile station is also presently engaged in an on-going wireless communication session via, for example, another access network using the first wireless access technology. So configured, a determination can be made subsequent to establishing the new connection via the second wireless access technology that a handover of the existing wireless communication session can be advantageously effected.

By another approach, the access gateway can establish such a connection with the mobile station using the second wireless access technology while in fact also anticipating that a handover of an existing wireless communication session can be effected. Upon having established the new point of attachment using the second wireless access technology the access gateway may then again effect the aforementioned handover. This approach may offer certain advantages with respect to how and/or when the new connection becomes established and may also provide an opportunity for reduced latency with respect to effecting such a handover.

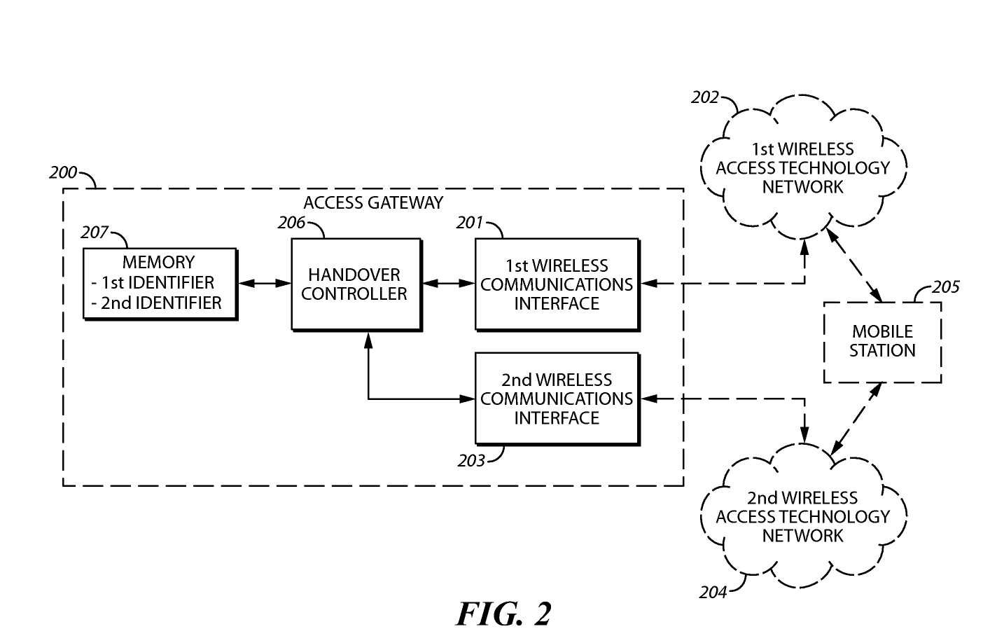

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

By one approach the aforementioned access gateway 200 can comprise a first wireless communication interface 201 that operably couples to a first wireless access technology network 202. This access gateway 200 can also comprise a second wireless communication interface 203 that operably couples to a second, different wireless access technology network 204. So configured, the access gateway 200 can interface compatibly with a suitably configured dual-mode mobile station 205 (i.e., a mobile station 205 that is configured and arranged to operate compatibly with both the first wireless access technology network 202 and the second wireless access technology network 204).

In this illustrative embodiment the access gateway 200 further comprises a handover controller 206 that operably couples to the aforementioned interfaces 201 and 203 as well as a memory 207. This memory 207 stores, at least in part, received information regarding the aforementioned first and second identifiers. So configured, the handover controller 206 can be suitably configured and arranged (via, for example, corresponding programming) as described herein to effect a handover of a wireless communication session for the mobile station from the first wireless access technology to the second wireless access technology using the first and second identifier.

As noted, this can comprise, if desired, establishing a connection with the mobile station using the second wireless access technology without anticipating the handover and then effecting the handover itself. In the alternative, if desired, this can comprise establishing the connection using the second wireless access technology while in fact anticipating the handover followed by effectuation of the handover itself.

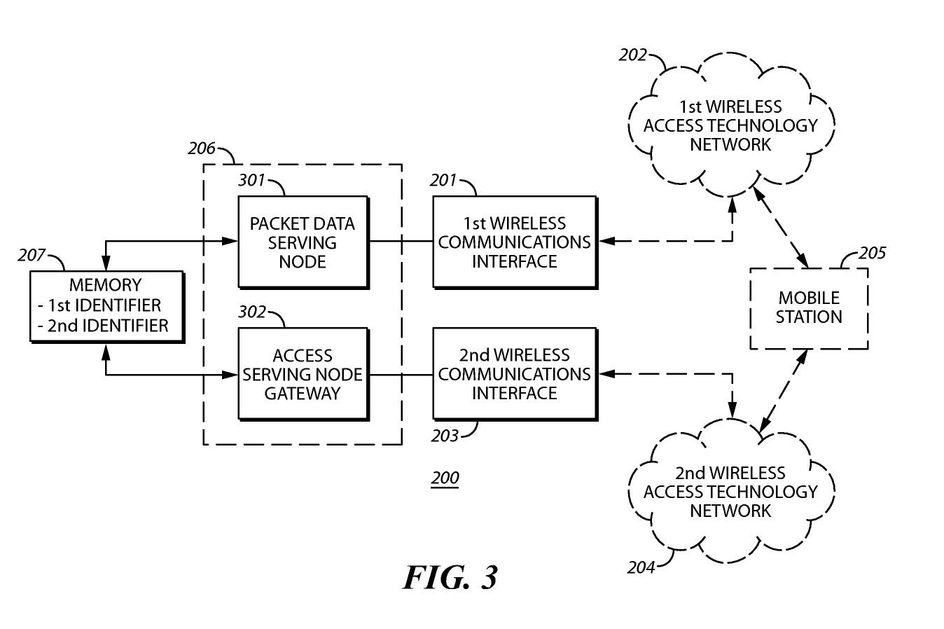

By one approach, and referring now to FIG. 3, the handover controller 206 can comprise, at least in part, a packet data serving node 301 and an access serving node gateway 302 (wherein both such network elements are known in the art). The packet data serving node 301 can be operably coupled to the first wireless communication interface 201 and thereby serve to facilitate mobile station communications via the first wireless access technology network 202. Similarly, the access serving node gateway 302 can be operably coupled to the second wireless communication interface 203 and thereby serve to facilitate mobile station communications via the second wireless access technology network 204. Such an architectural approach is known in the art and requires no further elaboration here.

By this approach, however, the packet data serving node 301 and the access serving node gateway 302 each also operably couple to the aforementioned memory 207 and to each other. These two network elements can be configured and arranged (again, if desired, via corresponding programming) to comport with the teachings set forth herein. So configured, these two network elements can cooperate with one another with respect to usage of the first and second identifiers when effecting handovers of existing wireless communication sessions from one of the wireless access technologies to the other.

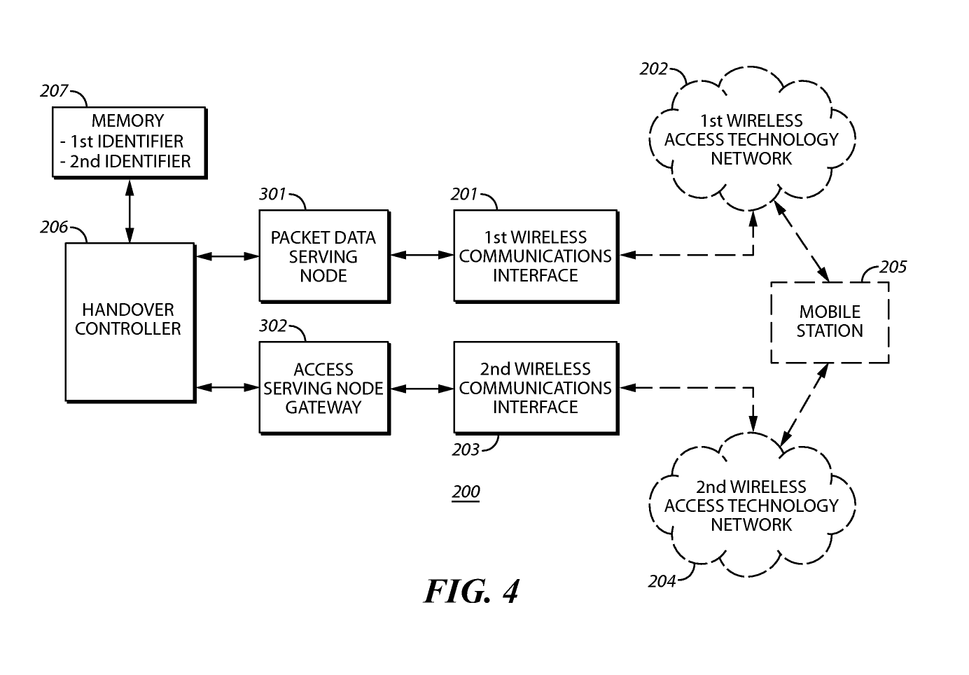

As yet another illustrative example in this regard, and referring now to FIG. 4, the handover controller 206 can be configured discretely from the packet data serving node 301 and the access serving node gateway 302. So configured, the latter network elements can operate in accordance with relatively typical prior art practice with the handover controller 206 assuming the functional task of using the mobile station identifiers to effectuate handovers from one wireless access technology to the other.

Those skilled in the art will recognize and understand that such an access gateway 200 may be comprised of a plurality of physically distinct elements as is suggested by the illustrations shown in FIGS. 2, 3, and 4. It is also possible, however, to view these illustrations as comprising logical views, in which case one or more of these elements can be enabled and realized via a shared platform. It will also be understood that such a shared platform may comprise a wholly or at least partially programmable platform as are known in the art.

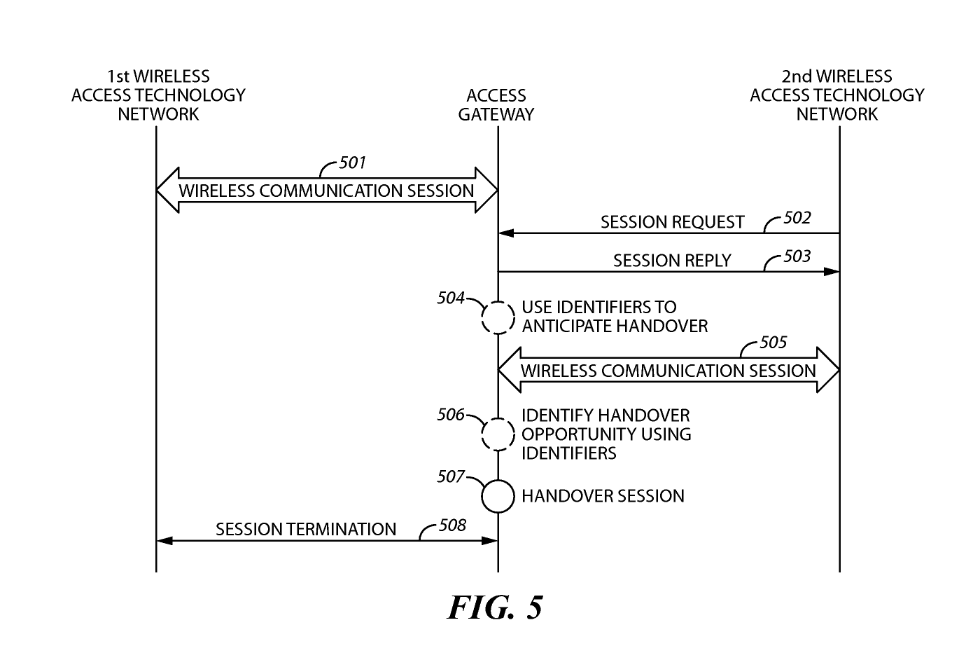

FIG. 5 provides an illustrative call flow depiction that accords with these various teachings. Those skilled in the art will understand and recognize that this depiction serves only an illustrative purpose and that other possibilities that will comport with these teachings are also available.

In this example an access gateway is supporting a present wireless communication session 501 for a given mobile station via a first wireless access technology network. That mobile station then sources a session request 502 via a second wireless access technology network. By one approach, this session request 502 presents the aforementioned first and second identifiers as correlate to this mobile station. The access gateway provides a corresponding session reply 503 and then optionally uses these received identifiers to anticipate handing over the already-existing wireless communication session 501. As noted above, such anticipation is optional and need not be practiced if so desired.

The access gateway then facilitates the establishment of the requested wireless communication session 505 for the mobile station via the second wireless access technology network. In a cases where the access gateway did not establish this wireless communication session 505 while anticipating 504 the handover opportunity, the access gateway can now identify 506 this handover opportunity by using these identifiers. In either case, the access gateway then effects a handover session 507 to move the previous wireless communication session 501 to the new wireless communication session 505 and terminates 508 the original session.

This handover can additionally comprise, if desired, updating a session entry to note this replacement of the serving technology by the newly established access technology. This can also comprise, if desired, such actions as reconciling accounting records for these various serving technologies and/or the creation of a new accounting recording as pertains to support of the ongoing wireless communication session using the newly established point of attachment.

So configured, the access gateway is readily able to effectuate handovers of existing wireless communication session from one network to another notwithstanding that such networks may be utterly different from one another using identifiers that are otherwise already assigned and/or used by the mobile station. In particular, this approach permits identifying a particular mobile station as being compatible with multiple technologies and then using that information to inform a handover process as between differing technologies. Those skilled in the art will appreciate that these teachings are readily scalable and can be applied with essentially any number of different wireless access technologies. It will further be understood that these teachings can be used in a manner that provides for seamless, or a near-seamless, handover of an existing wireless communication session.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an access gateway:
providing a first wireless access technology;
providing at least a second wireless access technology, wherein the second wireless access technology is different than the first wireless access technology;
using the first wireless access technology to facilitate provision of a wireless communication session with a mobile station;
receiving a first identifier that correlates the mobile station to the first wireless access technology and a second identifier that correlates the mobile station to the second wireless access technology;
effecting a handover of the wireless communication session for the mobile station from the first wireless access technology to the second wireless access technology using the first identifier and the second identifier.

2. The method of claim 1 wherein providing a first wireless access technology comprises providing one of a CDMA2000-compatible wireless access technology and an 802.16(e)-compatible wireless access technology.

3. The method of claim 2 wherein providing a second wireless access technology comprises providing an 802.16(e)-compatible wireless access technology when the first wireless access technology comprises a CDMA2000-compatible wireless access technology and providing a CDMA2000-compatible wireless access technology when the first wireless access technology comprises an 802.16(e)-compatible wireless access technology.

4. The method of claim 1 wherein using the first wireless access technology to facilitate provision of a wireless communication session with a mobile station comprises using the first wireless access technology to facilitate provision of a voice communication.

5. The method of claim 1 wherein using the first wireless access technology to facilitate provision of a wireless communication session with a mobile station comprises using the first wireless access technology to facilitate provision of a data communication.

6. The method of claim 1 wherein receiving a first identifier comprises receiving at least one of:
an international mobile subscriber identity (IMSI);
an electronic serial number (ESN);
a mobile equipment identifier (MEID);
a network access identifier (NAI);
a media access control (MAC) address.

7. The method of claim 6 wherein receiving a second identifier comprises receiving at least one of:
an international mobile subscriber identity (IMSI);
an electronic serial number (ESN);
a mobile equipment identifier (MEID);
a network access identifier (NAI);
a media access control (MAC) address.

8. The method of claim 1 wherein receiving a first identifier that correlates the mobile station to the first wireless access technology and a second identifier that correlates the mobile station to the second wireless access technology comprises receiving the first identifier and the second identifier as sourced by the mobile station.

9. The method of claim 1 wherein receiving a first identifier that correlates the mobile station to the first wireless access technology and a second identifier that correlates the mobiles station to the second wireless access technology comprises receiving the first identifier and the second identifier in a shared message.

10. The method of claim 1 wherein effecting a handover of the wireless communication session for the mobile station from the first wireless access technology to the second wireless access technology using the first identifier and the second identifier comprises:
establishing a connection with the mobile station using the second wireless access technology without anticipating the handover;
effecting the handover of the wireless communication session for the mobile station from the first wireless access technology to the second wireless access technology using the connection.

11. The method of claim 1 wherein effecting a handover of the wireless communication session for the mobile station from the first wireless access technology to the second wireless access technology using the first identifier and the second identifier comprises:
establishing a connection with the mobile station using the second wireless access technology in anticipation of the handover;
effecting the handover of the wireless communication session for the mobile station from the first wireless access technology to the second wireless access technology using the connection.

12. The method of claim 1 wherein effecting a handover comprises, at least in part, facilitating handover communications between a packet data serving node and an access serving node (ASN) gateway that both comprise a part of the access gateway.

13. A method comprising:
at an access gateway:
providing a CDMA2000-compatible wireless access technology;
providing an 802.16(e)-compatible wireless access technology, wherein the an 802.16(e)-compatible wireless access technology is different than the CDMA2000-compatible wireless access technology;
using one of the CDMA2000-compatible wireless access technology and the 802.16(e)-compatible wireless access technology to facilitate provision of a wireless communication session with a mobile station;
receiving a first identifier that correlates the mobile station to the CDMA2000-compatible wireless access technology and a second identifier that correlates the mobile station to the an 802.16(e)-compatible wireless access technology;
effecting a handover of the wireless communication session for the mobile station from one to another of the CDMA2000-compatible wireless access technology and the 802.16(e)-compatible wireless access technology using the first identifier and the second identifier.

14. The method of claim 13 wherein receiving a first identifier comprises receiving at least one of:
an international mobile subscriber identity (IMSI);
an electronic serial number (ESN);
a mobile equipment identifier (MEID);
a network access identifier (NAI);
a media access control (MAC) address.

15. The method of claim 14 wherein receiving a second identifier comprises receiving at least one of:
an international mobile subscriber identity (IMSI);
an electronic serial number (ESN);
a mobile equipment identifier (MEID);
a network access identifier (NAI);
a media access control (MAC) address.

16. The method of claim 13 wherein effecting a handover of the wireless communication session comprises:
establishing a connection with the mobile station using one of the 802.16(e)-compatible wireless access technology and the CDMA2000-compatible wireless access technology other than the one that is used to facilitate provision of the wireless communication session with the mobile station without anticipating the handover;
effecting the handover using the connection.

17. The method of claim 13 wherein effecting a handover of the wireless communication session comprises:
establishing a connection with the mobile station using one of the 802.16(e)-compatible wireless access technology and the CDMA2000-compatible wireless access technology other than the one that is used to facilitate provision of the wireless communication session with the mobile station in anticipation of the handover;
effecting the handover using the connection.

18. An access gateway comprising:
a first wireless communications interface that is configured and arranged to support a first wireless communication technology;
a second wireless communications interface that is configured and arranged to support a second wireless communication technology that is different than the first wireless communications interface;
a memory having stored therein received information regarding:
a first identifier that correlates a mobile station to the first wireless access technology; and
a second identifier that correlates the mobile station to the second wireless access technology;
a handover controller that is operably coupled to the first wireless communications interface, the second wireless communications interface, and the memory and being configured and arranged to effect a handover of a wireless communication session for the mobile station from the first wireless access technology to the second wireless access technology using the first identifier and the second identifier.

19. The access gateway of claim 18 wherein one of the first wireless access technology and the second wireless access technology comprises a CDMA2000-compatible wireless access technology.

20. The access gateway of claim 19 wherein a remaining one of the first wireless access technology and the second wireless access technology comprises an 802.16(e)-compatible wireless access technology.

21. The access gateway of claim 18 wherein the wireless communication session comprises at least one of:
a voice communication;
a data communication.

22. The access gateway of claim 18 wherein the first identifier comprises at least one of:
an international mobile subscriber identity (IMSI);
an electronic serial number (ESN);
a mobile equipment identifier (MEID);
a network access identifier (NAI);
a media access control (MAC) address.

23. The access gateway of claim 22 wherein the second identifier comprises at least one of:
an international mobile subscriber identity (IMSI);
an electronic serial number (ESN);
a mobile equipment identifier (MEID);
a network access identifier (NAI);
a media access control (MAC) address.

24. The access gateway of claim 18 wherein the handover controller comprises means for:
establishing a connection with the mobile station using the second wireless access technology without anticipating the handover;
effecting the handover of the wireless communication session for the mobile station from the first wireless access technology to the second wireless access technology using the connection.

25. The access gateway of claim 18 wherein the handover controller comprises means for:
establishing a connection with the mobile station using the second wireless access technology in anticipation of the handover;
effecting the handover of the wireless communication session for the mobile station from the first wireless access technology to the second wireless access technology using the connection.

26. The access gateway of claim 18 further comprising:
a packet data serving node that operably couples to the handover controller; and
an access serving node (ASN) gateway that operably couples to the handover controller;
and wherein the handover controller comprises means for facilitating handover communications between the packet data serving node and the ASN gateway.
